(19) United States
(12) Patent Application Publication
(10) Pub. No.: US 2009/0319699 A1
(43) Pub. Date: Dec. 24, 2009

(54) Preventing Loss of Access to a Storage System During a Concurrent Code Load

(75) Inventors: Christopher Canto, Hampshire (GB); Thomas William Rickard, Hants (GB)

Correspondence Address: DUKE W. YEE;YEE & ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/144,315

(22) Filed: Jun. 23, 2008

(51) Int. Cl. G06F 3/00; G06F 12/00

(52) U.S. Cl. 710/17; 711/E12.001

(57) ABSTRACT

Illustrative embodiments provide a computer implemented method for minimizing loss of access to a storage system during a concurrent controller code load in a redundant dual controller subsystem. The computer implemented method receives a request for a controller code load, verifies all required hosts are connected with the second controller to form a first verification, and responsive to the first verification indicating that all required hosts are connected with the second controller, varies a first controller offline. The controller code load is performed in the first controller, and the first controller is varied back online. The computer implemented method performs a verification that all required hosts are connected with the first controller to form a second verification, and responsive to the second verification indicating that all required hosts are connected with the first controller, varies the second controller offline, and performs the controller code load in the second controller.

### BACKGROUND OF THE INVENTION

1. Field of the Invention

The present invention relates generally to an improved data processing system and more specifically to a computer implemented method, a data processing system and a computer program product for preventing loss of access to a storage system during a concurrent code load.

2. Description of the Related Art

Currently there is frequent need to allow firmware and software on a storage subsystem to be upgraded concurrently with host I/O still running. Performing a concurrent upgrade operation in this manner, does not require any downtime for the host system and host based applications. The typical approach is to utilize dual controllers which can be upgraded independently. The attached host systems are each responsible for handling I/O failover and fallback actions to the controllers during the upgrade process. The failover and fallback actions are typically performed by employing a multi-pathing driver such as the IBM® Subsystem Device Driver (SDD) to perform path discovery and recovery.

In the event of configuration error or fault on a host system software and or hardware, the host may not maintain connectivity to the storage subsystem while each controller goes through an offline-install-online sequence. If a path to the first controller is not recovered before the second controller is taken offline, then the host system will experience a loss of access to the storage system, causing an impact to the host applications.

Equally, it is a user's responsibility to verify that all host systems are operating with redundant links to the storage subsystem before starting a controller code upgrade process. This particular approach typically does not scale well in storage area network (SAN) environments where there can be many hosts using storage on a given subsystem. This is especially true of environments employing virtualization, using technology such as the IBM storage area network volume controller, where there can be more than one thousand hosts accessing a storage device cluster.

### BRIEF SUMMARY OF THE INVENTION

According to one embodiment of the present invention, a computer implemented method for minimizing loss of access to a storage system during a concurrent controller code load in a redundant dual controller subsystem receives a request for a controller code load, verifies all required hosts are connected with the second controller to form a first verification, and responsive to the first verification indicating that all required hosts are connected with the second controller, varies a first controller offline. The controller code load is performed in the first controller, and the first controller is varied back online. A verification of all required hosts are connected with the first controller to form a second verification, and responsive to the second verification indicating that all required hosts are connected with the first controller, vary the second controller offline, and perform the controller code load in the second controller.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a storage load controller in accordance with illustrative embodiments; and

FIG. 4 is a flowchart of a controller code load process in accordance with illustrative embodiments.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

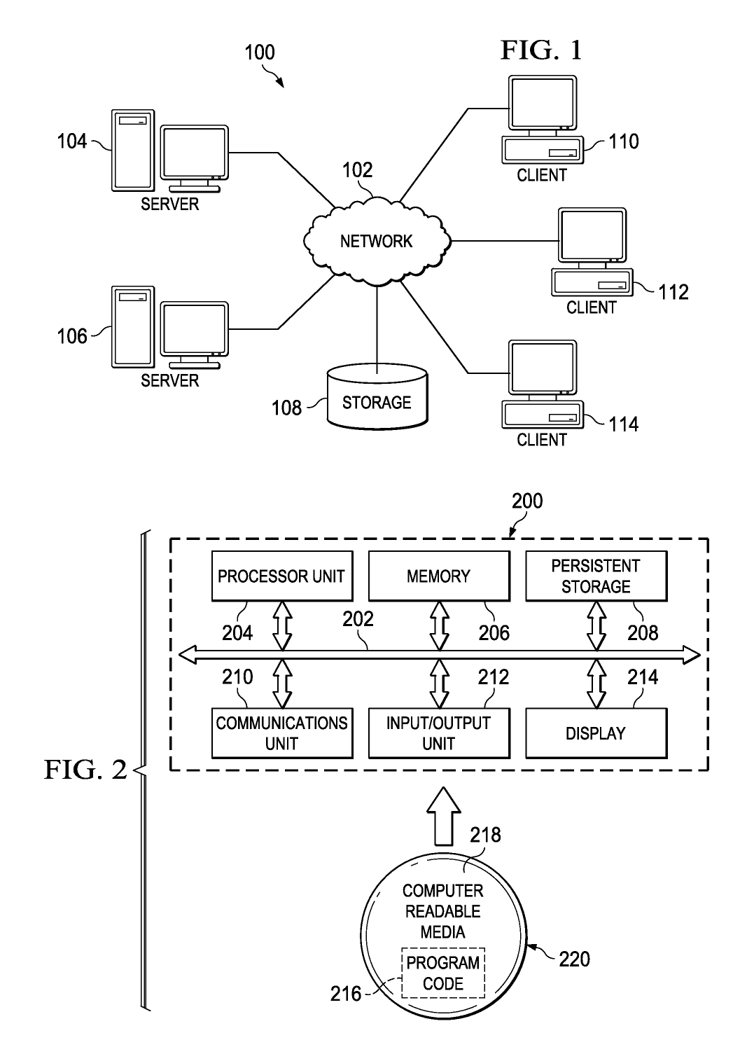

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

Illustrative embodiments provide additional logic which can be incorporated into the code load process of a storage subsystem to ensure a controller or node is only taken offline when all host systems have redundant access via the partner controller or node. The redundant access prevents a loss of access during a code upgrade. For example, the use of storage 108 by servers 104 and 106 may use dual controllers to provide multiple host system access to storage 108. When one controller has support for all systems, the other controller may be taken offline for code load. This path support allows servers 104 and 106 to continue to access data in storage 108 while a code load is performed on the other controller.

Illustrative embodiments can typically be applied directly in the controller or cluster software, requiring no changes to any of the attached host systems. The lack of change typically makes the illustrative embodiments ideal for large heterogeneous environments. The same logic used during the code load process is also able to provide an initial check that all active host systems are operating with redundant links to the storage subsystem before starting the code upgrade process. This avoids the user having to manually inspect the connectivity of each host before starting an upgrade.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

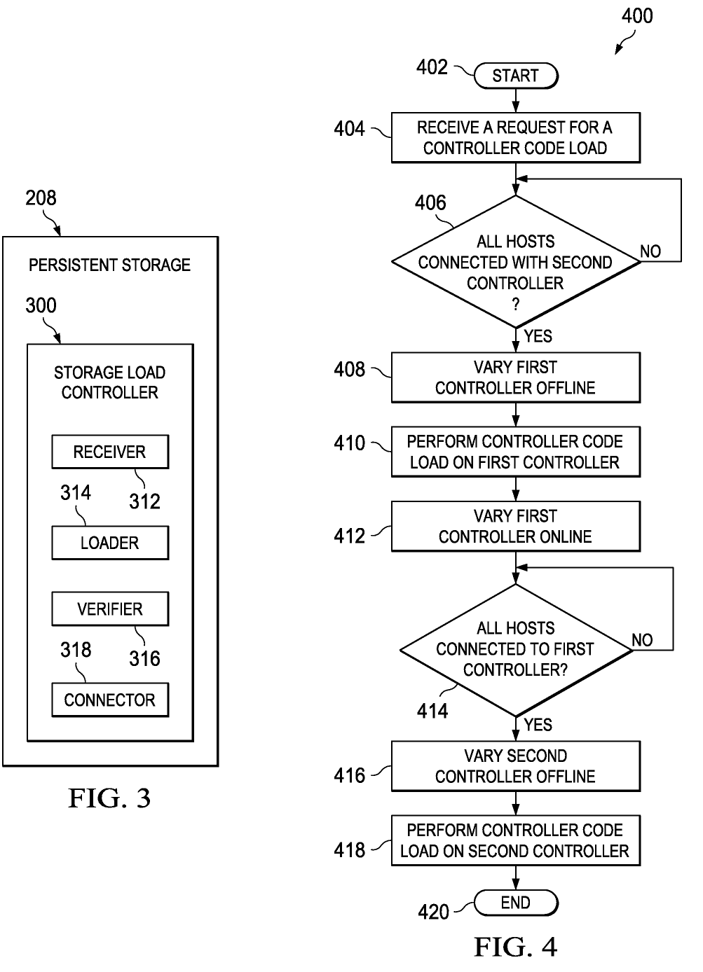

With reference to FIG. 3, a block diagram of a storage load controller in accordance with illustrative embodiments is shown. Storage load controller 300 is shown located within memory of persistent storage 208. A number of components comprise storage load controller 300 including, receiver 312, loader 314, verifier 316 and connector 318.

Storage load controller 300 comprises the management service needed to integrate the components that comprise the load controller. Receiver 312 provides a capability to receive instructions and code for loading firmware and software of the storage controller on which it operates. Loader 314 provides the operational capability to install or load the received firmware and software for the designated storage controller. Verifier 316 determines the status of the loaded code upon completion of the load process. Verifier 316 determines if the load was successful. Verifier 316 does not perform a function test on the code. The loaded code is presumed to be operational and meets functional requirements prior to load. Connector 318 determines connectivity to the designated host systems by confirming connections and reports any missing host connections.

Additional support may be provided in the form of user interface through which the load process may me initiated, monitored and controlled. Notification of progress or failure conditions may also be reported through the user interface according to know messaging techniques.

With reference to FIG. 4, a flowchart of a controller code load process in accordance with illustrative embodiments is shown. In the example shown, process 400 is an example of a controller code load using storage load controller 300 of FIG. 3. Process 400 starts (step 402) and receives a request for a controller code load of the first controller (step 404). A determination is made whether all hosts are connected with the second controller (step 406). The dual controller mechanism provides a first and second controller or pair of controllers, as presumed. Host connectivity involves determining whether each host in a set of hosts has established a login to both the first controller and the second controller and responsive to determination that each host in a set of hosts has established the login to both the first controller and the second controller, only then removing redundancy prior to the code load.

If all hosts are not connected to the second controller, a “no” results in step 406. If all hosts are connected to the second controller a “yes” is obtained in step 406. When a “no” is returned in step 406, process 400 reverts to step 406 to determine connectivity status again. When a “yes” is obtained in step 406, the first controller is varied offline (step 408). The controller is varied offline to allow for the code load to occur and the controller code load is performed (step 410).

Having completed the first controller code load, the first controller is varied online (step 412). A determination is made whether all hosts are connected to the first controller (step 414). If all hosts are not connected, a “no” results in step 414. If all hosts are connected a “yes” results in step 414. When a “no” is obtained in step 414, process 400 reverts to step 414 to determine connectivity status. A period of time may be allowed for the recovery of connections previously dropped due to the code load.

A verification is performed determining whether each host in a set of hosts has established a login to both the first controller and the second controller and responsive to a determination that each host in a set of hosts has not established the login to both the first controller and the second controller, identifying each host in the set of hosts that failed to establish a login to form a set of identified hosts. The identified hosts are reported using a unique identifier for each identified host in the set of identified hosts and the controller code load is prevented from occurring. When a “yes” is obtained in step 414, a vary offline of second controller occurs (step 416). Having varied the second controller offline, a controller code load for the second controller occurs (step 418), with process 400 terminating thereafter (step 420). The upgrade of the controllers is complete. The varying of the second controller online and subsequent verifying all required hosts are connected with the first controller and second controller occurs.

A typical code load in a redundant dual controller subsystem follows a sequence of receiving the code, checking connectivity to confirm redundancy of paths, and varying a respective controller offline and performing the code load. Upon successful completion of the code load, varying the controller back online and re-establishing host connectivity is performed. Host connectivity may be presumed if there is establishment of host logins. The system therefore checks for redundant host connections prior to any offline action such as a code load. The update procedure would occur only when all hosts had established redundant paths or connections with the storage subsystems. There may be situations where a load may be forced in the absence of redundancy, such as when in a single path controller environment.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for minimizing loss of access to a storage system during a concurrent controller code load in a redundant dual controller subsystem, the computer implemented method comprising:
receiving a request for a controller code load;
first verifying all required hosts are connected with a second controller to form a first verification; and
responsive to the first verification indicating that all required hosts are connected with the second controller, first varying a first controller offline;
performing the controller code load in the first controller;
second varying the first controller online;
second verifying all required hosts are connected with the first controller to form a second verification; and
responsive to the second verification indicating that all required hosts are connected with the first controller, third varying the second controller offline; and
performing the controller code load in the second controller.

2. The computer implemented method of claim 1, wherein responsive to verifying all required hosts are connected with the first controller, third varying the second controller offline and performing the controller code load further comprises:
fourth varying the second controller online; and
verifying all required hosts are connected with the first controller and the second controller.

3. The computer implemented method of claim 1, wherein verifying all required hosts are connected further comprises:
determining whether each host in a set of hosts has established a login to both the first controller and the second controller; and
responsive to determination that each host in a set of hosts has established the login to both the first controller and the second controller, removing redundancy.

4. The computer implemented method of claim 1, wherein verifying all required hosts are connected with the second controller to form a first verification; further comprises:
determining whether each host in a set of hosts has established a login to both the first controller and the second controller; and
responsive to a determination that each host in a set of hosts has not established the login to both the first controller and the second controller, identifying each host in the set of hosts that failed to establish a login to form a set of identified hosts;
reporting a unique identifier for each identified host in the set of identified; and
preventing the controller code load.

5. A data processing system for minimizing loss of access to a storage system during a concurrent controller code load in a redundant dual controller subsystem, the data processing system comprising:
a bus;
a memory connected to the bus, wherein the memory comprising computer executable instructions;
a processor unit connected to the bus, wherein the processor unit executes the computer executable instructions to direct the data processing system to:
receive a request for a controller code load;
first verify all required hosts are connected with a second controller to form a first verification; and
responsive to the first verification indicating that all required hosts are connected with the second controller, first vary a first controller offline;
perform the controller code load in the first controller;
second vary the first controller online;
second verify all required hosts are connected with the first controller to form a second verification; and
responsive to the second verification indicating that all required hosts are connected with the first controller, third vary the second controller offline; and
perform the controller code load in the second controller.

6. The data processing system of claim 5, wherein responsive to the second verification that all required hosts are connected with the first controller, third vary the second controller offline and perform the controller code load in the second controller further comprises:
fourth vary the second controller online; and
verify all required hosts are connected with the first controller and the second controller.

7. The data processing system of claim 5, wherein first verify all required hosts are connected with a second controller to form a first verification further comprises:
determine whether each host in a set of hosts has established a login to both the first controller and the second controller; and
responsive to a determination that each host in a set of hosts has established the login to the first controller and the second controller, remove redundancy.

8. The data processing system of claim 5, wherein first verify all required hosts are connected with a second controller to form a first verification further comprises:
determine whether each host in a set of hosts has established a login to both the first controller and the second controller;
responsive to a determination that each host in a set of hosts has not established a login to both controllers, identify each host in the set of hosts that failed to establish the login to create an identified host;
report a unique identifier for each identified host; and
prevent the controller code load.

9. A computer program product for minimizing loss of access to a storage system during a concurrent controller code load in a redundant dual controller subsystem, the computer program product comprising:
a computer usable recordable type medium embodying computer executable instructions thereon, the computer executable instructions comprising:
computer executable instructions for receiving a request for a controller code load;
computer executable instructions for first verifying all required hosts are connected with a second controller to form a first verification; and
computer executable instructions responsive to the first verification indicating that all required hosts are connected with the second controller, for first varying a first controller offline;
computer executable instructions for performing the controller code load in the first controller;
computer executable instructions for second varying the first controller online;
computer executable instructions for second verifying all required hosts are connected with the first controller to form a second verification; and
computer executable instructions responsive the second verification indicating that all required hosts are connected with the first controller, for third varying the second controller offline; and
computer executable instructions for performing the controller code load in the second controller.
